(19) United States
(12) Patent Application Publication
(10) Pub. No.: US 2016/0300302 A1
(43) Pub. Date: Oct. 13, 2016

(54) DISTRIBUTION OF MARKET DATA UPDATES IN AN ELECTRONIC TRADING SYSTEM

(71) Applicant: TRADING TECHNOLOGIES INTERNATIONAL, INC., CHICAGO, IL (US)

(72) Inventor: Scott F. Singer, Green Oaks, IL (US)

(21) Appl. No.: 14/680,730

(22) Filed: Apr. 7, 2015

(51) Int. Cl. G06Q 40/04

(52) U.S. Cl. CPC G06Q 40/04

(57) ABSTRACT

Certain embodiments provide methods, tangible computer storage medium, and systems of distribution of market data updates in an electronic trading system. An example method includes assigning a first wireless device of a plurality of wireless devices to access a first update of common market data from an exchange and a second wireless device of the plurality of wireless devices to access a second update of the common market data from the exchange upon receiving a handoff indicator. The example method also includes accessing the first update via a first network between the exchange and the first wireless device and relaying the handoff indicator to the second wireless device after the first update is accessed. The second wireless device is to access the second update from the exchange via a second network after the handoff indicator is received from the first wireless device.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Mobile or wireless trading devices (e.g., wireless trading devices such as a smart phone, and a tablet) generally communicate with the electronic exchange via a wireless communication network. One or more conditions (e.g., conditions such as remaining battery power of the mobile trading device, and reaching a designated allotment of data consumption) can affect communication between the mobile trading device and the electronic exchange via the wireless communication network.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example distribution network in accordance with the teachings herein.

FIG. 5 illustrates another example distribution network in accordance with the teachings herein.

FIG. 6 illustrates a block diagram of an example system in which certain embodiments may be employed.

FIG. 7 illustrates an example method to distribute market data updates via a distribution network.

FIG. 8 illustrates an example method to access a market data update which may be employed within the method of FIG. 7.

FIG. 9 illustrates an example method to replace a trading device of a distribution network which may be employed within the method of FIG. 7.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading systems and, more specifically, to distribution of market data updates in an electronic trading system.

Trading devices, such as mobile or portable trading devices (e.g., hand-held devices, laptops, tablets, netbooks, cell phones, and portable computing devices), establish a communication link (e.g., via a wireless communication network) with an exchange via a gateway. A state of one or more conditions of the trading device (e.g., a remaining battery power, and a designated allotment of data consumption), the communication link (e.g., a connectivity level of the mobile trading device) and/or the gateway (memory usage at the gateway) may impair communication between the trading device and the exchange. For example, if the trading device is approaching a monthly data consumption allotment, an amount of data communicated between the trading device and the exchange via the communication link may be limited.

Embodiments disclosed herein include distribution of market data updates in an electronic trading system. Certain embodiments disclosed and described herein include a first trading device that is assigned to access a first update of common market data from an exchange and a second trading device that is assigned to access a second update of the common market data from the exchange. The first trading device accesses the first update via a first network and subsequently relays a handoff indicator to the second trading device. The second trading device accesses the second update via a second network after receiving the handoff indicator from the first trading device.

In some examples, the first and second updates of the common market data are distributed between the first trading device and the second trading device via a shared communication network. In some examples, the first trading device schedules a plurality of trading devices to access updates of the market data in an iterative or repeating cycle. In some examples, a third trading device is assigned to access a third update of the common market data after the third trading device has received the handoff indicator from the second trading device.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Certain embodiments provide a method including assigning a first wireless device of a plurality of wireless devices to access a first update of common market data from an exchange and a second wireless device of the plurality of wireless devices to access a second update of the common market data from the exchange upon receiving a handoff indicator. The example method also includes accessing the first update via a first network between the exchange and the first wireless device and relaying the handoff indicator to the second wireless device after the first update is accessed. The second wireless device is to access the second update from the exchange via a second network after the handoff indicator is received from the first wireless device.

Certain embodiments provide a tangible computer readable storage medium including instructions which, when executed, cause a machine to at least assign a first wireless device of a plurality of wireless devices to access a first update of common market data from an exchange and a second wireless device of the plurality of wireless devices to access a second update of the common market data from the exchange upon receiving a handoff indicator. The instructions which, when executed, also cause the machine to access the first update via a first network between the exchange and the first wireless device and relay the handoff indicator to the second wireless device after the first update is accessed. The second wireless device is to access the second update from the exchange via a second network after the handoff indicator is received from the first wireless device.

Certain embodiments provide a system including a computing device configured to assign a first wireless device of a plurality of wireless devices to access a first update of common market data from an exchange and a second wireless device of the plurality of wireless devices to access a second update of the common market data from the exchange upon receiving a handoff indicator. The computing device is also configured to access the first update via a first network between the exchange and the first wireless device and relay the handoff indicator to the second wireless device after the first update is accessed. The second wireless device is to access the second update from the exchange via a second network after the handoff indicator is received from the first wireless device.

### II. EXAMPLE ELECTRONIC TRADING SYSTEM

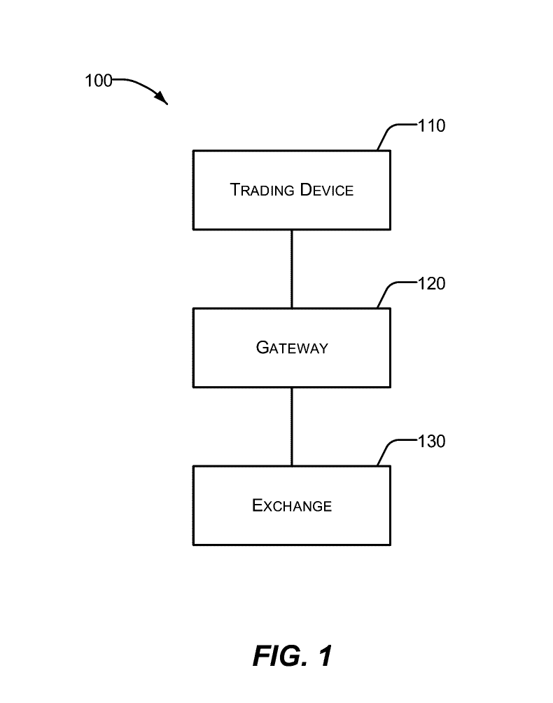

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

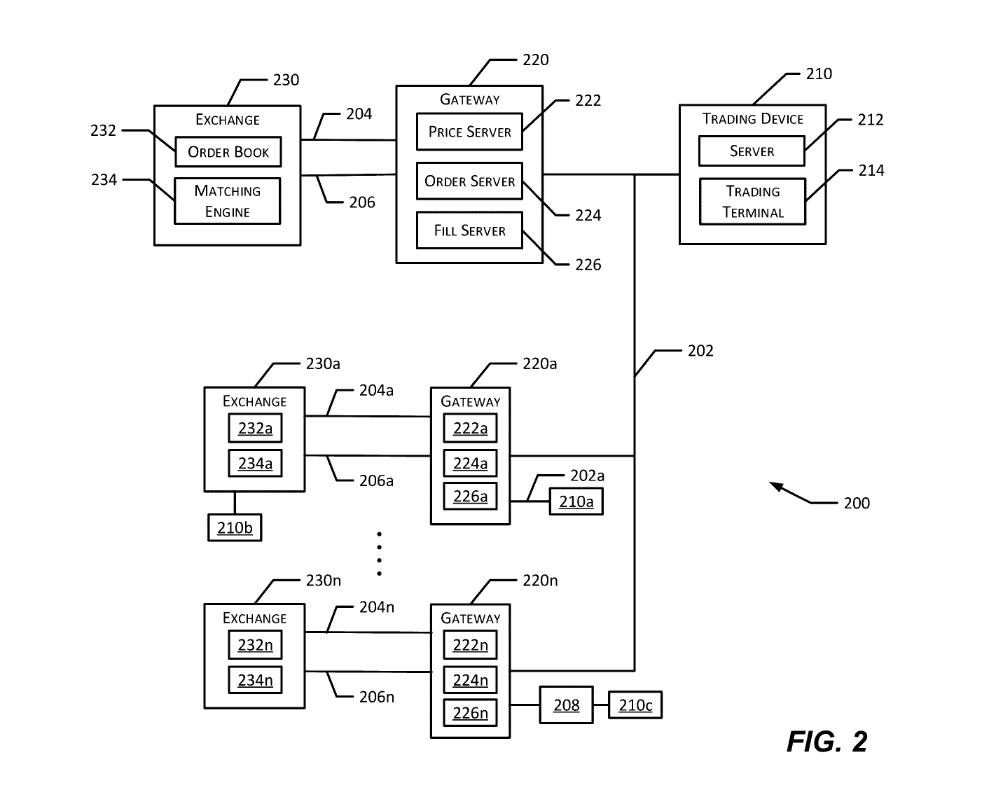

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components. The trading device 210 may be a wired device or a wireless device and may be a stationary device or a mobile device (e.g., a portable computing device such as a hand-held device, a laptop, a tablet, a cell phone, and a netbook).

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

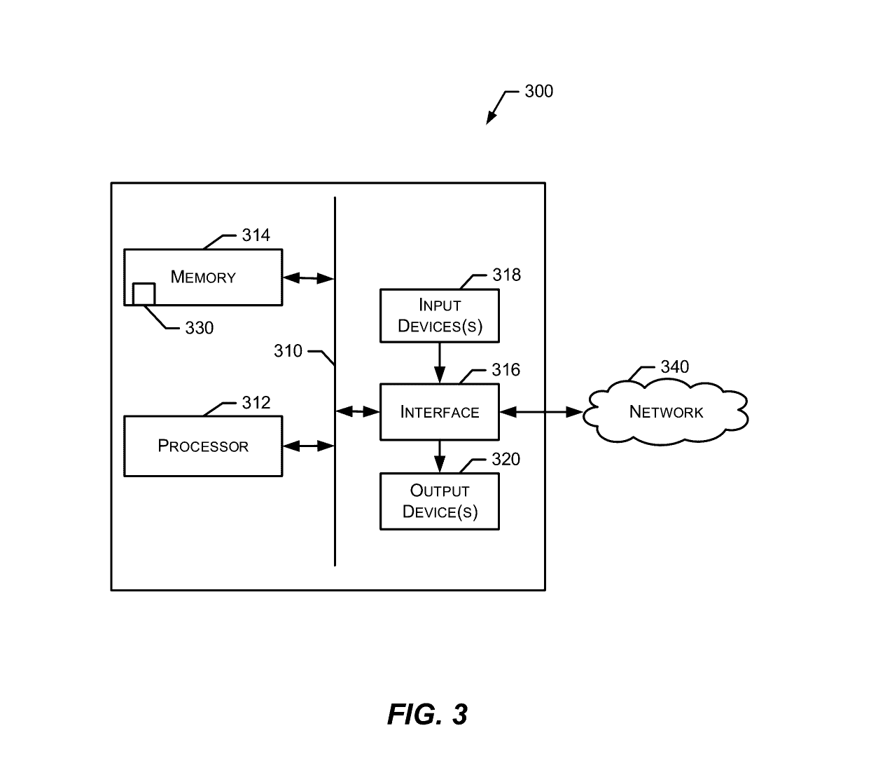

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example. The computing device 300 may be a wired or wireless computing device and may be a mobile (e.g., a portable computing device such as a hand-held device, a laptop, a tablet, a cell phone, and a netbook) or stationary computing device.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or machine or a combination of devices or machines, such as one or more devices or machines associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. DISTRIBUTION OF MARKET DATA UPDATES

Example methods, tangible computer storage media, and systems of distribution of market data updates in an electronic trading system are disclosed herein. Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market. Market data updates reflect changes in market data between, for example, two points in time, quantity of traded tradeable objects, a fixed number of trades, and/or other criteria defined to trigger communication of the update. For example, a market data update may reflect that the inside market, the market depth, the LTP and/or the LTQ has changed since a preceding market data update.

In certain examples a trading device (e.g., a mobile or portable trading device, such as a hand-held device, a laptop, a tablet, a cell phone, a portable computing device, and a netbook) may communicate with an exchange to access market data utilizing one or more communication links (e.g., a wireless communication network, a wired communication network and an ad-hoc or peer-to-peer communication network). In some examples, the trading device communicates with the exchange via a gateway such that the communication link is established between the trading device and the gateway. For example, the communication link may be a wireless communication network that provides a channel for the wireless communication of messages between the trading device and the gateway. Communication via the trading device may be affected by one or more communication conditions. Communication conditions include functions, characteristics and/or attributes of the mobile trading device, the gateway, and/or the wireless communication network that enable, affect and/or support communication between the mobile trading device and the gateway via the communication link. For example, the communication conditions of a mobile trading device include: the remaining battery power of the device, the amount of remaining data of a designated allotment, and/or a connectivity level (e.g., a signal strength at the device).

To mitigate a risk that communication between the trading device and an exchange is interrupted, the disclosed examples describe the methods, systems and devices utilized to distribute market data updates between trading devices utilizing a shared communication link and/or a shared communication network. For example, the shared communication network connects a plurality of trading devices that are each individually in communication with the exchange via corresponding communication links. In some examples, the communication links are in communication with the exchange via a gateway. In some examples, a machine or computing device (e.g., one of the trading devices in communication with the shared communication network) schedules an iterative or repeating cycle for the plurality of trading devices to access and distribute updates of common market data from the exchange. Common market data includes market data that is mutually requested by all, or part, of the trading devices of the shared communication network. Thus, common market data includes information that has been, or could be, requested by multiple trading devices on the shared communication network, for example.

In some examples, a first trading device is assigned to access a first update of the common market data, a second trading device is assigned to access a second update of the common market data, and a third trading device is assigned to access a third update of the common market data. To prevent any of the trading devices from accessing a market data update out of sequence (e.g., not in an assigned chronological order), each trading device accesses a market data update only upon receiving a handoff indicator (e.g., a handshake, a key, a baton, a button, a token). The handoff indicator is, for example, a signal sent from one trading device to another trading device to enable the other trading device to access a market data update. In some examples, the handoff indicator includes a first signal that is generated by the first trading device and relayed to the second trading device, a second signal that is generated by the second trading device and relayed to the third trading device, etc. In some examples, the handoff indicator includes a generated signal that is relayed from the first trading device to the second trading device, from the second trading device to the third trading device, etc.

For example, after the first trading device accesses the first update of the common market data from the exchange via a first communication link, the first trading device relays the handoff indicator to the second trading device and distributes the first update to the second and third trading devices. Upon receiving the handoff indicator, the second trading device accesses the second update of the common market data via a second communication link. Subsequently, the second trading device distributes the second update to the first and third trading devices and relays the handoff indicator to the third trading device to enable the third trading device to access the third update of the common market data via a third communication link.

As described in conjunction with FIG. 2 above, the example trading device 210a may be a mobile or portable trading device such as, for example, a hand-held device, a laptop, a tablet, a cell phone, a portable computing device, and a netbook. In the current examples, the network 202a is a wireless communication network (e.g., a Wi-Fi network, a cellular or mobile network such as, for example, a Global System for Mobile Communications (GSM) network, a Personal Communications Service (PCS) network, a Digital Advanced Mobile Phone Service (D-AMPS) network, a 3G network, a 4G network, and/or any other wireless communication network), which may be terrestrial and/or satellite based.

When the trading device 210a is in communication with the gateway 220a, a communication link is established between the gateway 220a and the trading device 210a via the network 202a to enable the trading device 210a to interact with the gateway 220a. In some examples, the network 202a enables the trading device 210a to communicate with the gateway 220a and/or enables the gateway 220a to respond to instructions communicated by the trading device 210a. In some examples, a communication link is established between the trading device 210a and the exchange 230a to enable the trading device 210a to communicate directly with the exchange 230a.

The network 202a may be monitored (e.g., monitoring may occur substantially continuously, at predetermined intervals of time, and/or based on a location of the trading device 210a) to measure one or more communication conditions (e.g., functions, characteristics, and/or attributes of the trading device 210a, the gateway 220a, and/or the network 202a) that enable, affect, and/or support communication between the trading device 210a and the exchange 230a. The communication conditions include, for example, a strength of the signal of the network 202a received by the trading device 210a (e.g., a connectivity level of the trading device 210a), a remaining battery power of the trading device 210a, latency at the gateway 220a, an amount of data consumption of the trading device 210a and/or the gateway 220a, a CPU load at the gateway 220a, and/or other communication condition(s).

A communication state or network service state is a qualitative and/or quantitative measurement, value, and/or status of one or more communication conditions. The communication state reflects an ability of the trading device 210a to communicate with the exchange 230a via the network 202a. In some examples, the communication state is defined by the connectivity level of the trading device 210a with the network 202a. In some examples, an amount of risk is present that communication between the trading device 210a and the exchange 230a is interrupted if the communication state reaches or falls below a threshold state. For example, the threshold state may be a predetermined state of a communication condition at which a given amount of risk is present that communication between the trading device 210a and the exchange 230a will be interrupted.

In some examples, deterioration of one or more of the communication conditions interrupts (e.g., delay, render incomplete, and/or substantially impair) the trading device 210a from requesting and/or receiving market data (e.g., inside market, market depth, last traded place, last traded quantity) from the exchange 230a. For example, a lack of remaining battery power of the trading device 210a, a depleted allotment of data consumption, insufficient connectivity, and/or any other deteriorated condition of the communication state may prevent and/or delay the trading device 210a from sending requests to and/or receiving market data from the exchange 230a. As a result, a user may be prevented from monitoring market data developments when deciding to send an order message to buy or sell one or more tradeable objects. To mitigate a risk of interruption in the communication between the trading device 210a and the gateway 220a and/or the exchange 230a, updates of certain examples disclosed herein distribute updates of common market data between a plurality of trading devices in communication with the exchange 230a.

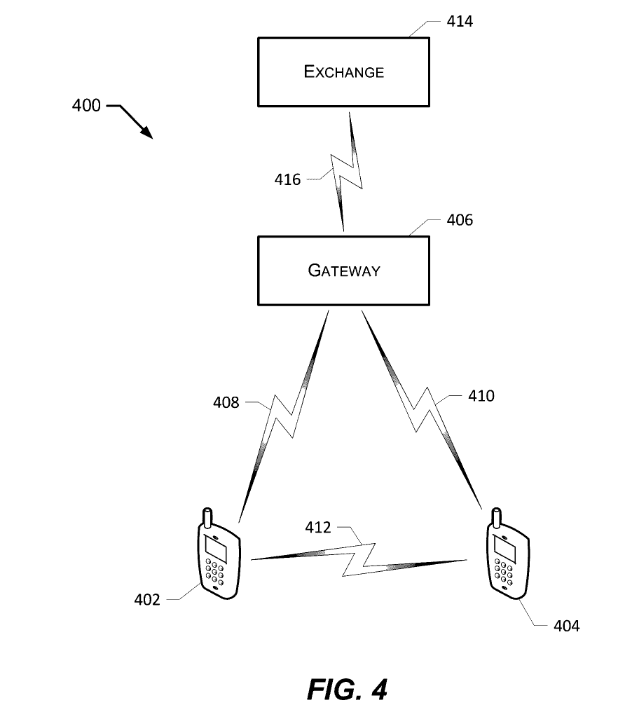

An example distribution network 400 is illustrated in FIG. 4. In the illustrated example, two trading devices 402, 404 are in communication with a gateway 406 via respective networks 408, 410 and are in communication with each other via a communication link 412. In the illustrated example of FIG. 4, the trading devices 402, 404 request and/or receive market data (e.g., contract data, price subscription data, order book data) and/or market data updates from an exchange 414 via the gateway 406 and a communication link 416 between the gateway 406 and the exchange 414. In some examples, the trading devices 402, 404 of the distribution network 400 communicate directly with the exchange 414.

In some examples, the trading devices 402, 404 have similar or identical characteristics as the trading devices 210, 210a-210n of FIG. 2, the networks 408, 410 have similar or identical characteristics as the networks 202, 202a of FIG. 2, the gateway 406 has similar or identical characteristics as the gateways 220, 220a-220n, the exchange 414 has similar or identical characteristics as the exchanges 230, 230a-230n of FIG. 2 and/or the communication link 416 has similar or identical characteristics as the paired networks 204, 204a-204n and 206, 206a-206n of FIG. 2. In the illustrated example, each of the trading devices 402, 404 is a mobile or portable trading device (e.g., a hand-held device, a laptop, a tablet, a cell phone, a portable computing device, and a netbook) and each of the networks 408, 410 is a wireless communication network (e.g., a Wi-Fi network, a cellular or mobile network such as, for example, a Global System for Mobile Communications (GSM) network, a Personal Communications Service (PCS) network, a Digital Advanced Mobile Phone Service (D-AMPS) network, a 3G network, a 4G network, and/or any other wireless communication network). The communication link 412 is, for example, a wireless or mobile ad hoc network (e.g., a network utilizing Bluetooth® protocol) in which each of the trading devices 402, 404 is a node that communicates with the other without a router and/or any other preexisting infrastructure.

When the trading devices 402, 404 are in communication with each other via the communication link 412, the communication state of at least one of the networks 408, 410 may deteriorate. For example, communication between the trading device 402 and the gateway 406 via the network 408 can be interrupted (e.g., communications may be delayed, rendered incomplete, and/or otherwise substantially impaired) such that an amount of market data that the trading device 402 is able to request and/or receive via the network 408 is substantially reduced. For example, too many trading devices 402, 404 communicating via the distribution network 400 may reduce available bandwidth for communication with the gateway 406 and/or the exchange 414. To conserve and/or reduce the amount of market data communicated via the network 408, the communication link 412 of the distribution network 400 enables the trading device 402 to receive market data updates via the trading device 404.

The distribution network 400 enables the trading devices 402, 404 to access and distribute updates of the market data based on an iterative, repeating or cyclical schedule. For example, the trading device 402 may be assigned to access first, third, and fifth updates of market data from the exchange 414 via the gateway 406 and the network 408, and the trading device 402 may be assigned to access second, fourth, and sixth updates of market data from the exchange 414 via the gateway 406 and the network 410. In some examples, to help ensure that the scheduled updates are updating common market data (e.g., market data mutually requested by the trading device 402 and the trading device 404), the trading devices 402, 404 access an initial set of market data via the respective networks 408, 410 substantially simultaneously before any of the updates are accessed via the trading devices 402, 404.

After the trading device 402 of the illustrated example accesses the first update of the market data via the network 408, the trading device 402 relays a handoff indicator (e.g., a handshake, a key, a baton, a button, and/or a token) to the trading device 404 via the communication link 412.

The handoff indicator relays, triggers, or instructs each of the trading devices 402, 404 to access an update of market data upon receiving the handoff indicator. For example, the trading device 404 of the illustrated example accesses the second update of the market data via the network 410 upon receiving the handoff indicator from the trading device 402. After the trading device 404 has relayed or sent the handoff indicator to another trading device (e.g., the trading device 402), the trading device 404 is prevented from accessing a market data update from the exchange 414. For example, upon sending the handoff indicator to the trading device 402 via the communication link 412 to relay, trigger, or instruct the trading device 402 to access the third update of the market data, the trading device 404 of FIG. 4 is prevented from accessing market data updates via the gateway 406.

In some examples, each update of market data is assigned a unique identification or sequence number. When the exchange 414 receives a request for an update of market data from one of the trading devices 402, 404, the unique identification or sequence number prevents the exchange 414 from repeatedly providing duplicative sets of market data to the trading devices 402, 404 of the distribution network 400. In some such examples, the unique identification number helps prevent the trading device 402 from accessing the third update of market data if the market data remains unchanged since the trading device 402 accessed and distributed the first update of market data. In some such examples, the unique identification number prevents the trading device 404 from accessing the second update of market data if the market data remains unchanged since the trading device 402 accessed the first update. In some examples, having a unique identification or sequence number helps ensure that market data updates are retrieved and received in a proper order.

In some examples, the trading devices 402, 404 distribute the accessed updates of the market data via the communication link 412. For example, the trading device 402 may distribute the first update to the trading device 404 via the communication link 412 before, during and/or after the trading device 402 relays the handoff indicator to the trading device 404 via the communication link 412. In some examples, the trading devices 402, 404 distribute the accessed updates of the market data via an email/messaging network such that the trading device 404 receives the first update via an email or message sent from the trading device 402. Distributing the accessed market data updates via the email/messaging network reduces the amount of data communicated via the communication link 412 and, thus, increases a rate at which the handoff indicator is relayed between the trading devices 402, 404.

Further, as a result of distributing updates of the market data via the distribution network 400, an amount of data communicated by each of the networks 408, 410 is reduced. Thus the distribution network 400 increases communication between the trading devices 402, 404 of the distribution network 400 and the gateway 406 when an operating state described by one or more conditions of the trading devices 402, 404 (e.g., conditions such as remaining battery power, a designated allotment of data consumption, and the like), the networks 408, 410 (e.g., a signal strength or connectivity level) and/or the gateway 406 is impaired. Further, because only one of the trading devices 402, 404 accesses each market data update from the exchange 414, the distribution network 400 increases available bandwidth resources of the exchange 414 and/or the gateway 406.

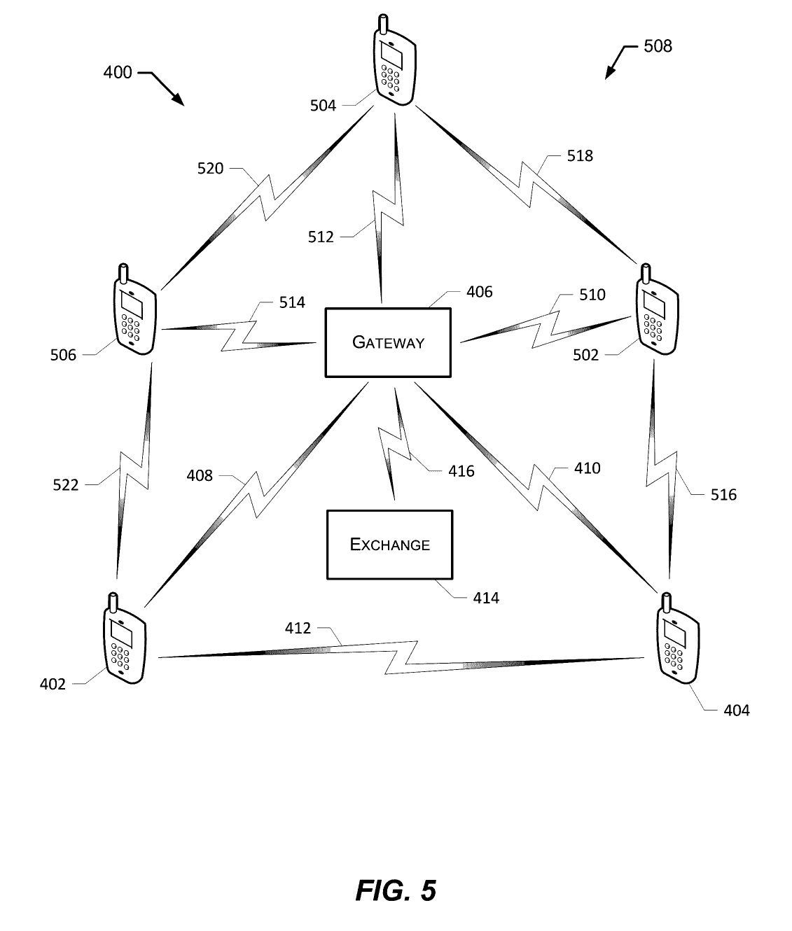

FIG. 5 illustrates another example of the distribution network 400. In the example illustrated in FIG. 5, trading devices 402, 404, 502, 504, 506 are in communication with each other via a shared communication network 508 and are in communication with the gateway 406 via respective networks 408, 410, 510, 512, 514. In some examples, the trading devices 402, 404, 502, 504, 506 of the distribution network 400 communicate directly with the exchange 414. The trading devices 402, 404, 502, 504, 506 are, for example, mobile or portable trading devices (e.g., hand-held devices, laptops, tablets, cell phones, portable computing devices, and netbooks) and the networks 408, 410, 510, 512, 514 are, for example, wireless communication networks (e.g., a Wi-Fi network, a cellular or mobile network such as a Global System for Mobile Communications (GSM) network, a Personal Communications Service (PCS) network, a Digital Advanced Mobile Phone Service (D-AMPS) network, a 3G network, a 4G network, and/or any other wireless communication network).

The shared communication network 508 of the illustrated example includes communication links 412, 516, 518, 520, 522. As illustrated in FIG. 5, the trading device 402 is in communication with the trading device 404 via the communication link 412, the trading device 404 is in communication with the trading device 502 via the communication link 516, the trading device 502 is in communication with the trading device 504 via the communication link 518, the trading device 504 is in communication with the trading device 506 via the communication link 520, and the trading device 506 is in communication with the trading device 402 via the communication link 522. The shared communication network 508 of the illustrated example is a wireless or mobile ad hoc network (e.g., a network utilizing Bluetooth® protocol) in which each of the trading devices 402, 404, 502, 504, 506 is a node that communicates with the other without a router and/or any other preexisting infrastructure. FIG. 5 illustrates an example of the distribution network 400 and, thus, the distribution network 400 may be connected to other trading devices without departing from the scope of this disclosure.

When the trading devices 402, 404, 502, 504, 506 of the distribution network 400 are in communication with each other via the shared communication network 508, the communication state of at least one of the corresponding networks 408, 410, 510, 512, 514 may deteriorate. For example, communication via the network 510 can be interrupted (e.g., delayed, rendered incomplete, substantially impaired) such that an amount of market data that the trading device 502 is able to request and/or receive via the network 510 is substantially reduced and/or restricted. To conserve and/or reduce the amount of market data communicated via the network 510, the distribution network 400 enables the trading device 502 to access at least some of the requested market data updates from the exchange 414 via the networks 408, 410, 512, 514 of the respective trading devices 402, 404, 504, 506.

The trading devices 402, 404, 502, 504, 506 of the illustrated example access and distribute updates of common market data based on an iterative, repeating or cyclical schedule. For example, the trading device 402 is assigned to access first and sixth updates of common market data (e.g., market data that is mutually requested by all of the trading devices 402, 404, 502, 504, 506 of the distribution network 400) from the exchange 414 via the network 408 and the gateway 406. Further, the trading device 404 is assigned to access second and seventh updates of the common market data from the exchange 414 via the network 410 and the gateway 406, the trading device 502 is assigned to access third and eighth updates of the common market data from the exchange 414 via the network 510 and the gateway 406, the trading device 504 is assigned to access fourth and ninth updates of the common market data from the exchange 414 via the network 512 and the gateway 406, and the trading device 506 is assigned to access fifth and tenth updates of the common market data from the exchange 414 via the network 514 and the gateway 406.

In some examples, the trading device 402 accesses the first update of the common market data via the network 408 and subsequently relays a handoff indicator (e.g., a handshake, a key, a baton, a button, and a token) to the trading device 404 via the communication link 412. Upon receiving the handoff indicator from the trading device 402, the trading device 404 accesses the second update of the common market data via the network 410 and subsequently relays the handoff indicator to the trading device 502 via the communication link 516. After the trading device 502 receives the handoff indicator from the trading device 404, the trading device 502 accesses the third update of the common market data via the network 510 and subsequently relays the handoff indicator to the trading device 504. Upon receiving the handoff indicator from the trading device 502, the trading device 504 accesses the fourth update of the common market data via the network 512 and subsequently relays the handoff indicator to the trading device 506 via the communication link 520. After the trading device 506 receives the handoff indicator from the trading device 504, the trading device 506 accesses the fifth update of the common market data via the network 514 and subsequently relays the handoff indicator to the trading device 402. Once the handoff indicator returns to the trading device 402, the iterative cycle repeats for updates six through ten, updates eleven through sixteen, etc. In some examples, the trading devices 402, 404, 502, 504, 506 distribute the accessed updates of the common market data via the communication links 412, 516, 518, 520, 522 of the shared communication network 508 and/or via an email/messaging network.

Upon receiving the handoff indicator, each of the trading devices 402, 404, 502, 504, 506 may wait a predetermined amount of time (e.g., 30 seconds, 60 seconds, 90 seconds, etc.) before accessing an assigned update via the respective network 408, 410, 510, 512, 514. For example, to reduce the amount of updates accessed within a period of time, the trading device 404 may wait 30 seconds after receiving the handoff indicator from the trading device 402 before accessing the second update of the common market data via the network 410. In other embodiments additional handoff indicators and/or triggers such as a change in signal strength (e.g., change from no signal to a signal, and/or changes from a low-powered signal to a high-powered signal), a user initiated “Get Data” command, and/or a change in the power status of the device (e.g., entering sleep mode, the transition to a screen saver mode) may be used to initiate an update.

In some examples, each update of common market data is assigned a unique identification or sequence number. When the exchange 414 receives an update request from one of the trading devices 402, 404, 502, 504, 506 of the distribution network 400, the unique identification or sequence number helps prevent the exchange 414 from repeatedly providing duplicative sets of market data (e.g., market data that each correspond to the unique identification number) to the trading devices 402, 404, 502, 504, 506 of the distribution network 400. In some such examples, the unique identification or sequence number helps prevent one of the trading devices (e.g., the trading device 402) from accessing an update (e.g., the sixth update) of the common market data if the common market data remains unchanged since the trading device accessed the previous update (e.g., the first update) assigned to the trading device. In some such examples, the unique identification or sequence number helps prevent a trading device (e.g., the trading device 502) from accessing an assigned update (e.g., the third update) of the market data if the market data remains unchanged since the preceding update (e.g., the second update) was accessed by the preceding trading device (e.g., the trading device 404).

Because the distribution network 400 distributes updates of common market data among the trading devices 402, 404, 502, 504, 506, data communicated by each of the networks 408, 410, 510, 512, 514 is reduced. Thus, the distribution network 400 increases communication between the trading devices 402, 404, 502, 504, 506 and the gateway 406 when a state of one or more conditions of the trading devices 402, 404, 502, 504, 506 (e.g., remaining battery power, a designated allotment of data consumption, etc.), the networks 408, 410, 510, 512, 514 (e.g., a signal strength or connectivity level) and/or the gateway 406 impairs and/or restricts communication with the exchange 414. Further, because only one of the networks 408, 410, 510, 512, 514 accesses each market data update from the exchange 414, the distribution network 400 increases available bandwidth resources of the exchange 414 and/or the gateway 406. If an update to any one of the trading devices, 402, 404, 502, 504, 506 fails to complete, the next device in the communication sequence may attempt to access the missing update after a predetermined timeout period has been reached.

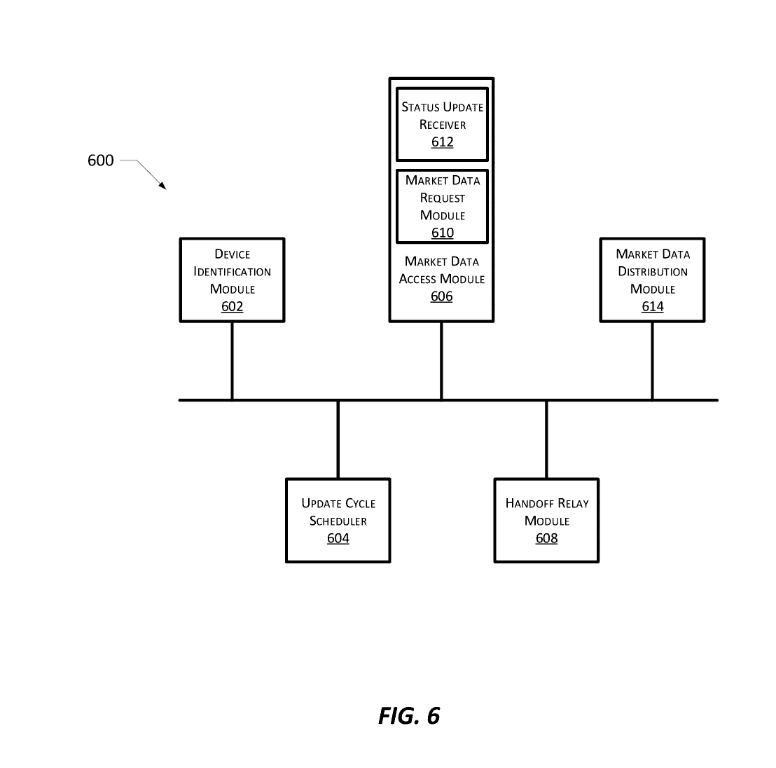

FIG. 6 illustrates a block diagram of an example system 600 that may be employed to distribute updates of common market data via a distribution network (e.g., the distribution network 400 of FIGS. 4 and 5). In some examples, the system 600 is implemented as part of software and/or an application associated with the trading device 402 of FIGS. 4 and 5, the trading device 404 of FIGS. 4 and 5, the trading device 502 of FIG. 5, the trading device 504 of FIG. 5, the trading device 506 of FIG. 5 and/or the gateway 406 of FIGS. 4 and 5. In some examples, the system 600 is implemented as computer implemented code or instructions operable independent of software associated with the trading device 402, the trading device 404, the trading device 502, the trading device 504, the trading device 506 and/or the gateway 406. In some examples, the features and functionality of the system 600 are implemented in hardware operable in connection with the trading device 402, the trading device 404, the trading device 502, the trading device 504, the trading device 506 and/or the gateway 406.

The example system 600 of FIG. 6 includes a device identification module 602 that identifies trading devices in communication with the exchange 414. For example, if the system 600 is associated with the trading device 402, the device identification module 602 identifies the other trading devices of the distribution network 400 (e.g., the trading device 404 of FIGS. 4 and 5, the trading devices 502, 504, 506 of FIG. 5). In some examples, the device identification module 602 of FIG. 6 identifies whether each of the other trading devices (e.g., the trading devices 404, 502, 504, 506) is configured to share data via a shared communication network (e.g., the shared communication network 508 of FIG. 5), communication link(s) (e.g., the communication link 412 of FIGS. 4 and 5, the communication link 516 of FIG. 5, the communication link 518 of FIG. 5, the communication link 520 of FIG. 5 and/or the communication link 522 of FIG. 5) and/or an email/messaging network.

In some examples, the device identification module 602 reviews one or more configuration settings to identify trading devices (e.g., the trading devices 404, 502, 504, 506) that another trading device (e.g., the trading device 402) is configured to communicate. For example, each trading device can be configured to communicate with all other nearby trading devices identified by the device identification module 602. Alternatively, a trading device can be configured to share with only those trading devices identified by the device identification module 602 as being associated with the trading device. For example, if the user of the trading device is a member of a trading group, the trading device can be configured to share common market data with only those trading devices associated with other members of the trading group. The trading device can also be configured to enable a user to individually select and/or authorize the other trading devices with which the trading device to communicate. Furthermore, the trading device can be configured to share market data with only those trading devices configured to reciprocate sharing of market data.

The example system 600 includes an update cycle scheduler 604 that schedules a cycle for accessing updates of common market data (e.g., market data mutually requested by all trading devices of a distribution network). In some examples, the update cycle scheduler 604 schedules an iterative or repeating cycle in which the update cycle scheduler 604 assigns each of the trading devices (e.g., the trading devices 402, 404, 502, 504, 506) of the distribution network 400 to access an update within each cycle of the schedule. For example, the update cycle scheduler 604 may assign the trading device 402 to access first and sixth updates of the common market data, the trading device 404 to access second and seventh updates of the common market data, the trading device 502 to access third and eighth updates of the common market data, the trading device 504 to access fourth and ninth updates of the common market data, and the trading device 506 to access fifth and tenth updates of the common market data.

In some examples, the update cycle scheduler 604 modifies the scheduled cycle when another trading device is identified. For example, if the scheduled cycle initially includes the trading devices 402, 404, 502, 504 and the device identification module 602 subsequently identifies the trading device 506, the update cycle scheduler 604 modifies the cycle to include the trading devices 402, 404, 502, 504, 506.

The update cycle scheduler 604 of the illustrated example modifies the scheduled cycle when one of the identified trading devices disconnects from or leaves the distribution network 400 (e.g., when the device identification module 602 is no longer able to identify the trading device). A trading device disconnects from the distribution network 400 if, for example, the trading device lacks battery power, moves outside a communicative range of the distribution network 400, no longer requests the common market data and/or reaches a designated allotment of data consumption. For example, if the trading device 502 leaves the distribution network 400 that also includes the trading devices 402, 404, the update cycle scheduler 604 modifies the cycle such that only the trading devices 402, 404 are assigned to access updates of the common market data. In some such examples, the update cycle scheduler 604 reschedules the cycle such that the trading device 402 is assigned to access a first update, a third update, a fifth update, etc. and the trading device 404 is assigned to access a second update, a fourth update, a sixth update, etc. In other such examples, the update cycle scheduler 604 replaces the trading device 502 by assigning one of the two remaining trading devices 402, 404 to access the updates that were initially assigned to the trading device 502. In some examples, the system 600 is implemented as part of or associated with a lead trading device (e.g., the trading device 402) of the distribution network 400. If the lead trading device disconnects from the other trading devices (e.g., the trading devices 404, 502, 504, 506), the distribution network 400 deteriorates. In some such examples, the remaining trading devices form a new distribution network and a new lead trading device is selected from the remaining trading devices.

A market data access module 606 of the example system 600 accesses updates of the common market data from the exchange 414. For example, the market data access module 606 accesses common market data updates via the gateway 406. In some examples, the market data access module 606 enables the trading device 402 to access an update of common market data via the network 408, the trading device 404 to access an update of common market data via the network 410, the trading device 502 to access an update of the common market data via the network 510, the trading device 504 to access an update of the common market data via the network 512 and/or the trading device 506 to access an update of the common market data via the network 514.

As illustrated in FIG. 6, the example system 600 includes a handoff relay module 608 that sends indicators (e.g., a handoff indicator) between trading devices (e.g., the trading devices 402, 404, 502, 504, 506) of a distribution network (e.g., the distribution network 400) via communication links (e.g., the communication links 412, 516, 518, 520, 522) of a shared communication network (e.g., the shared communication network 508). For example, the handoff relay module 608 sends indicators between the trading device 402 and the trading device 404 via the communication link 412, between the trading device 404 and the trading device 502 via the communication link 516, between the trading device 502 and the trading device 504 via the communication link 518, between the trading device 504 and the trading device 506 via the communication link 520, and between the trading device 506 and the trading device 402 via the communication link 522.

In some examples, the market data access module 606 enables only the trading device that has received the handoff indicator (e.g., a handshake, a key, a baton, a button, a token) to access an update of the common market data via the respective network. For example, when the handoff relay module 608 relays the handoff indicator from the trading device 402 to the trading device 404 via the communication link 412, the market data access module 606 accesses the common market data via the network 410 associated with the trading device 404 and prevents the common market data from being accessed via the networks 408, 510, 512, 514 of the other respective trading devices 402, 502, 504, 506. Once the handoff relay module 608 relays the handoff indicator from the trading device 404 to another trading device (e.g., the trading device 504), the market data access module 606 prevents the network 410 associated with the trading device 404 from accessing the common market data.

As illustrated in FIG. 6, the market data access module 606 includes a market data request module 610 that enables a trading device (e.g. the trading devices 402, 404, 502, 504, 506) to request access of an update of the common market data from the exchange 414 via a respective network (e.g., the networks 408, 410, 510, 512, 514). In some examples, the market data request module 610 requests an update of the common market data after the handoff relay module 608 relays the handoff indicator to a trading device (e.g., one of the trading devices 402, 404, 502, 504, 506). In some such examples, the market data access module 606 waits a predetermined amount of time (e.g., 30 seconds, 60 seconds, 90 seconds, etc.) after the market data request module 610 requests the assigned update of the common market data before accessing the update assigned to the trading device. For example, upon the trading device 502 receiving the handoff indicator, the market data request module 610 requests the third update of the common market data for the trading device 502. To reduce the amount of updates accessed within a period of time, the market data access module 606 waits the predetermined amount of time before accessing the third update assigned to the trading device 502. In some other examples, the market data request module 610 waits a predetermined period of time (e.g., 30 seconds, 60 seconds, 90 seconds, etc.) after the handoff relay module 608 relays the handoff indicator to a trading device (e.g., one of the trading devices 402, 404, 502, 504, 506) before requesting the update assigned to the trading device.

As illustrated in FIG. 6, the market data access module 606 includes a status update receiver 612 that identifies whether the common market update has changed since the preceding update of the common market data was accessed. If the status update receiver 612 identifies that the common market update is different than the preceding update, the market data access module 606 accesses the requested update of the common market data. If the status update receiver 612 indicates that the common market data remains unchanged since the previous update accessed by the market data access module 606, the market data access module 606 does not access the requested update until the common market data changes. In some examples, if the status update receiver 612 identifies that the common market data has remained unchanged for a predetermined of time (e.g., three minutes, four minutes, five minutes, etc.), the handoff relay module 608 sends a standby indicator to other trading devices (e.g., the trading devices 402, 404, 502, 504, 506) of the distribution network 400 via a shared communication network (e.g., the shared communication network 508). The standby indicator indicates to the other trading devices of the distribution network 400 that the market data access module 606 is currently waiting for the common market data to change.

For example, if the market data request module 608 requests the fourth update for the trading device 504, the status update receiver 612 identifies whether the common market data is different than the common market data of the third update that was accessed by the trading device 502. If the status update receiver 612 identifies that the fourth update is different than the third update, the market data access module 606 enables the trading device 504 to access the fourth update. If the status update receiver 612 identifies that the common market data has remained unchanged for a predetermined period of time, the handoff relay module 608 sends the standby indicator and the market data access module 606 waits to access the fourth update until the common market data changes.

In some examples, to help prevent the market data access module 606 from accessing duplicative updates of the common market data from the exchange 414, the market data access module 606 assigns each update a unique identification or sequence number. The market data access module 606 prevents a trading device from accessing an update of the common market data if the status update receiver 612 identifies that the unique identification or sequence number of the present common market data has the same unique identification number as the previously accessed update. For example, if the status update receiver 612 identifies that the unique identification or sequence number of the present common market data matches that of the first update accessed by the trading device 402, the market data access module 606 prevents the trading device 404 from accessing the second update of the common market data.

As illustrated in FIG. 6, the example system 600 includes a market data distribution module 614. After the market data access module 606 enables a trading device (e.g., the trading device 502) to access an update of the common market data from the exchange 414, the market data distribution module 614 distributes the accessed update of the common market data to other trading devices (e.g., the trading devices 402, 404, 504, 506) of the distribution network 400.

In some examples, the market data distribution module 614 distributes the accessed updates of the common market data via communication links (e.g., the communication links 412, 516, 518, 520, 522) of a shared communication network (e.g., the shared communication network 508). In some examples, the market data distribution module 614 distributes an update of the common market data from the trading device 402 to the trading device 404 via the communication link 412 before, during and/or after the handoff relay module 608 relays the handoff indicator to the trading device 404 via the communication link 412. In some examples, the market data distribution module 614 distributes the accessed updates of the market data via an email/messaging network. In some such examples, the market data distribution module 614 distributes an update of the common market data from the trading device 402 to the trading device 404 via the email/messaging network as the handoff relay module 608 relays the handoff indicator to the trading device 404 via the communication link 410.

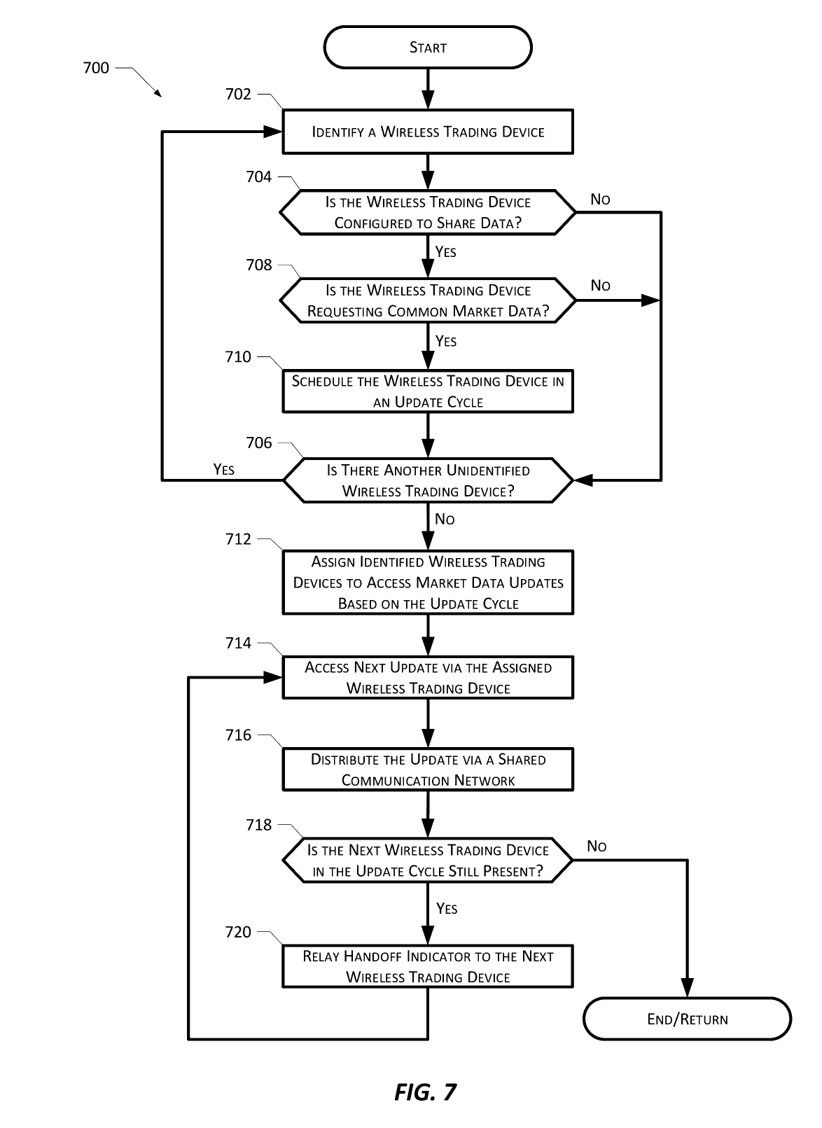

FIG. 7 illustrates an example method 700 to distribute market data updates via the distribution network 400. The example method 700 may be performed by any wireless trading device (e.g., the trading devices 402, 404 of FIGS. 4 and 5, the trading devices 502, 504, 506 of FIG. 5) and/or gateway (e.g., the gateway 406 of FIGS. 4 and 5). As illustrated in FIG. 7, the method 700 includes the device identification module 602 identifying a wireless trading device (e.g., the trading device 402 of FIGS. 4 and 5) that is in communication with an exchange (e.g., the exchange 414) (block 702).

After the device identification module 602 identifies the wireless trading device 402, the device identification module 602 verifies that the wireless trading device 402 is configured and/or enabled to share market data with other wireless trading devices (e.g., the trading device 404 of FIGS. 4 and 5, the trading devices 502, 504, 506 of FIG. 5) (block 704). The wireless trading device 402 may be configured to communicate with all other wireless trading devices identified by the device identification module 602, with only other wireless devices identified as being associated with the wireless trading device 402 (e.g., associated with a trading group), with only those wireless trading devices that a user individually selects and/or with only those wireless devices configured to share market data with the wireless trading device 402. In some examples, the wireless trading device 402 is configured to share market data via a shared communication network (e.g., the shared communication network 508 of FIG. 5), communication link(s) (e.g., the communication link 412 of FIGS. 4 and 5, the communication links 516, 518, 520, 522 of FIG. 5) and/or an email/messaging network.

If the wireless trading device 402 is not configured to share market data, the device identification module 602 determines whether there is another wireless trading device in communication with the exchange 414 that has yet to be identified (block 706). Otherwise, if the wireless trading device 402 is configured to share market data, the device identification module 602 determines whether the wireless trading device 402 is requesting any common market data (e.g., market data mutually requested by all other identified wireless trading devices) (block 708). For the first wireless trading device (e.g., the wireless trading device 402) identified by the device identification module 602, there is no previously identified wireless trading device with which to compare. As a result, block 708 of the example method 700 may be skipped for the first identified wireless trading device.

After block 708, the update cycle scheduler 604 schedules the wireless trading device 402 within an iterative or repeating cycle for accessing and distributing updates of the common market data (block 710). Once the wireless trading device 402 is scheduled in the update cycle, the device identification module 602 identifies whether there is another wireless trading device in communication with the exchange 414 that has yet to be identified (block 706).

If another wireless trading device is in communication with the exchange 414, blocks 702, 704, 706, 708, 710 of the example method 700 are repeated. For example, the device identification module 602 identifies the trading device 404 (block 702) and verifies that the wireless trading device 404 is configured to share market data with other identified trading devices (e.g., the wireless trading device 402) (block 704). The device identification module 602 determines whether the wireless trading device 404 is requesting any common market data (e.g., market data that is mutually requested by the wireless trading device 402 and the wireless trading device 404) (block 708). If there is no common market data between the wireless trading device 404 and the previously identified wireless trading device 402, the device identification module 602 determines whether there is another wireless trading device in communication with the exchange 414 that has yet to be identified (block 706). If there is commonly requested market data, the update cycle scheduler 604 schedules the wireless trading device 404 in the update schedule (block 710). As illustrated in FIG. 7, blocks 702, 704, 706, 708, 710 are repeated until all other wireless trading devices (e.g., the wireless trading devices 502, 504, 506) in communication with the exchange 414 are identified by the device identification module 602.

After the wireless trading devices have been identified, the update cycle scheduler 604 assigns the identified wireless trading devices to access updates of the common market data based on an update cycle (block 712). In some examples, the update cycle scheduler 604 schedules the identified wireless trading devices to access the updates of the common market data in an iterative or repeating cycle. For example, the update cycle scheduler 604 assigns the trading device 402 to access a first update, the trading device 404 to access a second update, the trading device 502 to access a third update, the trading device 504 to access a fourth update, and the trading device 506 to access a fifth update within each round or iteration of the update cycle.

Once the wireless trading devices 402, 404, 502, 504, 506 are assigned updates of the common market data within the update cycle, the market data access module 606 enables the wireless trading device (e.g., the wireless trading device 402) assigned a next update (e.g., the first update) to access the next update via a respective wireless network (e.g., the network 408) (block 714). In some examples, the market data access module 606 identifies the wireless trading device scheduled to access the next update by identifying which wireless trading device has last received a handoff indicator. In some such examples, the market data access module 606 enables only the wireless trading device having the handoff indicator to access an update of common market data via a respective wireless network and prevents any other wireless trading device of the distribution network 400 from accessing an update of the common market data.

After the market data access module 606 accesses the first update via the wireless network 408, the market data distribution module 614 distributes the first update of the common market data to the other wireless trading devices (e.g., the wireless trading devices 404, 502, 504, 506) of the distribution network 400 (block 716). In some examples, the market data distribution module 614 distributes the update assigned to the wireless trading device 402 via communication links (e.g., the communication links 412, 516, 518, 520, 522) of a shared communication network (e.g., the shared communication network 508). For example, the market data distribution module 614 distributes the first update of the common market data to the wireless trading device 404 via the communication link 412, the wireless trading device 502 via the communication links 412, 516, the wireless trading device 504 via the communication links 412, 516, 518 and/or the wireless trading device 506 via the communication links 412, 516, 518, 520. In other examples, the market data distribution module 614 distributes the first update of the market data to the wireless trading devices 404, 502, 504, 506 via an email/messaging network.

As illustrated in FIG. 7, after the market data access module 606 accesses the first update via the wireless network 408, the device identification module 602 identifies whether the wireless trading device assigned to access the next update of the common market data (e.g., the wireless trading device 404) in the update cycle remains in the distribution network 400 (block 718). The next wireless trading device disconnects from the distribution network 400 if, for example, the wireless trading device lacks battery power, moves outside a communicative range of the distribution network 400, no longer requests the common market data and/or reaches a designated allotment of data consumption. If the next wireless trading device is disconnected from the distribution network 400, the method 700 ends and/or returns to the start.

Otherwise, if the device identification module 602 identifies that the next wireless trading device remains in the distribution network 400, the handoff relay module 608 relays the handoff indicator to the wireless trading device assigned to access the next update of the common market data (block 720). For example, after the market data access module 606 accesses the first update via the wireless network 408, the handoff relay module 608 relays the handoff indicator to the wireless trading device 404 via the communication link 412 to enable wireless trading device 404 to access the second update of the common market data via the market data access module 606. In some examples, the handoff relay module 608 relays the handoff indicator to the next wireless trading device before, during and/or after the market data distribution module 614 distributes the accessed update across the distribution network 400.

As illustrated in FIG. 7, blocks 714, 716, 718, 720 repeat until a wireless trading device assigned to access the next update of the common market data disconnects from the distribution network 400. For example, blocks 714, 716, 718, 720 repeat to enable the wireless trading device 404 to access the second update of the update cycle, the wireless trading device 502 to access the third update of the update cycle, the wireless trading device 504 to access the fourth update of the update cycle, and the trading device 506 to access the fifth update of the update cycle. After the fifth update (e.g., the last update in the cycle) is accessed, the iterative cycle is repeated to enable the wireless device 402 to access a sixth update of common market data, the wireless trading device 404 to access a seventh update, the wireless trading device 502 to access an eighth update, the wireless trading device 504 to access a ninth update, and the trading device 506 to access a tenth update.

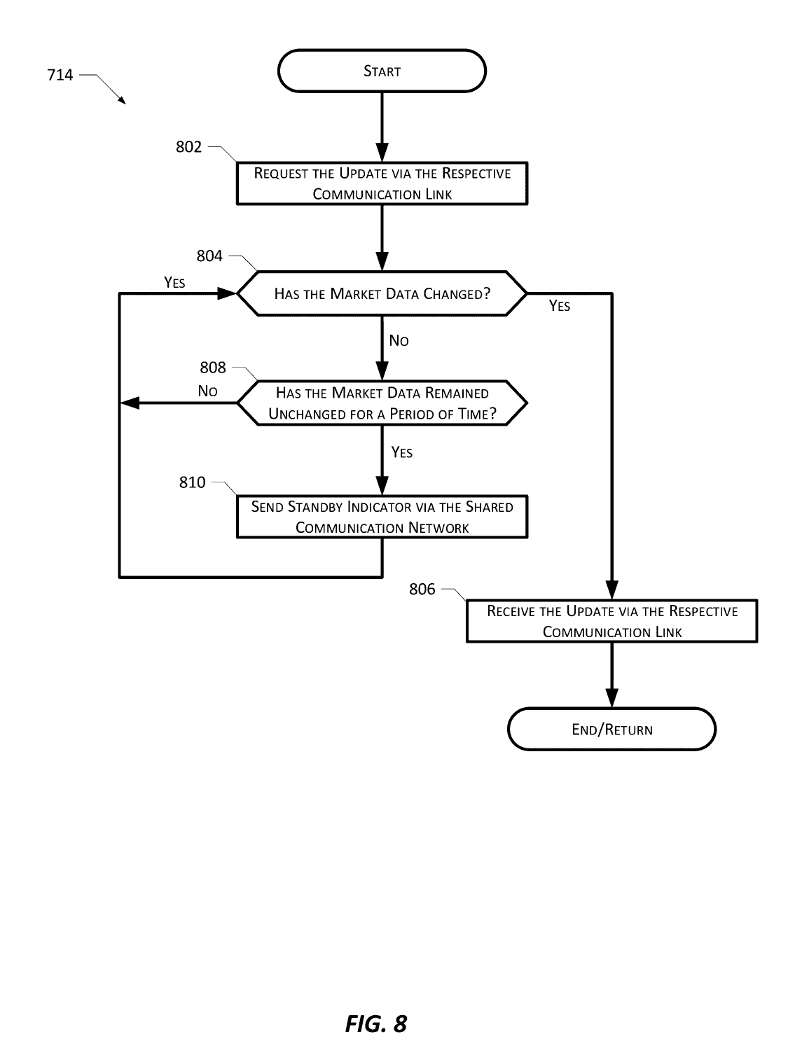

FIG. 8 illustrates additional detail regarding an example method 714 to access a next update within an update cycle via an assigned wireless trading device. As illustrated in FIG. 8, the example method 714 begins by the market data request module 610 of the market data access module 606 requesting the update of the common market data for the assigned wireless trading device (block 802). For example, the market data request module 610 requests a second update of the common market data for the wireless trading device 404 via a respective wireless network (e.g., the network 410). The market data request module 610 requests an update of the common market data after the handoff relay module 608 relays the handoff indicator to the trading device assigned to access the update. In some examples, to reduce an amount of updates accessed within a period of time, the market data request module 610 waits a predetermined period of time (e.g., 30 seconds, 60 seconds, 90 seconds, etc.) after the handoff relay module 608 relays the handoff indicator to a trading device before requesting the corresponding assigned update.

After the market data request module 610 requests the update from the exchange 414, the market data receiver 612 determines whether the market data has changed since the preceding update of the common market data was accessed (block 804). For example, if the market data request module 610 has requested the second update of the common market data assigned to the trading device 404, the market data receiver 612 determines whether the current or requested common market data is different than the first update accessed by the trading device 402. In some examples, to determine whether the common market data has changed since the preceding accessed update, the market data access module 606 assigns each update a unique identification or sequence number.

If the present common market data is different than the common market data of the preceding update, the market data access module 606 enables the assigned wireless trading device to access the update of the common market data via the respective wireless network (block 806). Upon receipt of the update of the common market data, the method 714 ends and/or returns to the method 700. In some examples, to reduce an amount of updates accessed within a period of time, the market data request module 610 waits a predetermined period of time (e.g., 30 seconds, 60 seconds, 90 seconds, etc.) after the common market data has changed before accessing the update of common market data.

If the common market data has not changed since the preceding update of the common market data, the market data receiver 612 monitors whether the common market data has remained unchanged for a predetermined period of time (e.g., three minutes, four minutes, five minutes, etc.) relative to the preceding update (block 808). If the market data receiver 612 identifies that the common market data has remained the same for less than the predetermined period of time, the example method 714 returns to block 804.

If the market data receiver 612 identifies that the common market data has remained the same for the predetermined period of time, the handoff relay module 608 relays a standby indicator to the other wireless trading devices of the distribution network 400 (block 810). The standby indicator indicates that the assigned wireless trading device is still present in the distribution network 400 and is currently waiting for the common market data to change. Thus, the standby indicator prevents the method 700 from ending prematurely as a result of a stagnant common market data. For example, if the status update identification module 612 identifies that the common market data has remained unchanged for three minutes since the market data access module 606 accessed the first update, the handoff relay module 608 relays the standby indicator to the other wireless trading devices 402, 502, 504, 506 via the communication links 412, 516, 518, 520, 522 of the shared communication network 508. In some examples, the handoff relay module 608 resets a toll period upon sending the standby indicator to enable the handoff relay module 608 to send another standby period if the common market data remains unchanged for another predetermined period of time (e.g., six minutes, eight minutes, ten minutes, etc. since the preceding update). As illustrated in FIG. 8, blocks 804, 808, 810 repeat until the common market data changes compared to the preceding accessed update.

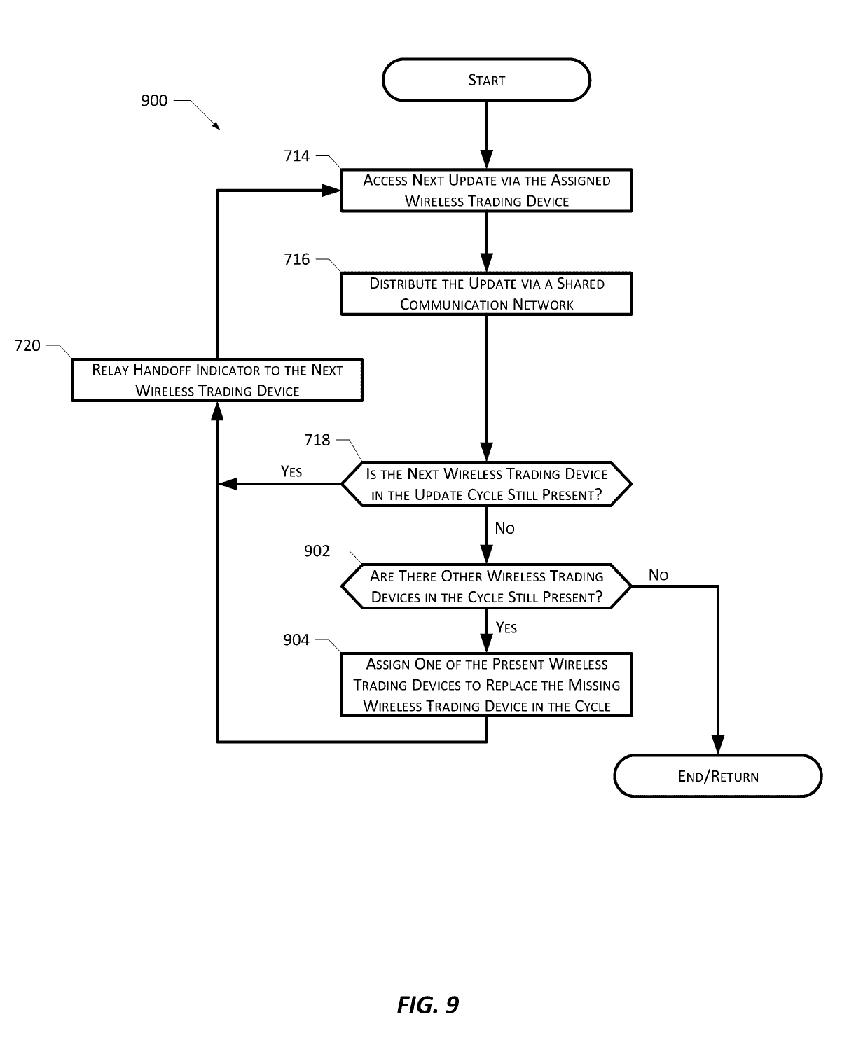

FIG. 9 illustrates an example method 900 that may be employed within or in conjunction with the method 700 to replace a wireless trading device that has disconnected from the distribution network 400. As illustrated in FIG. 9, the market data access module 606 enables an assigned wireless trading device (e.g., the wireless trading device 404) to access an update (e.g., the second update) of the common market data via a respective wireless network (e.g., a network 410) (block 714). The market data distribution module 614 distributes the accessed update of the common market data to other wireless trading devices (e.g., the wireless trading devices 402, 502, 504, 506) of the distribution network 400 (block 716).

Moreover, after the market data access module 606 accesses the update of the common market data, the device identification module 602 determines whether the wireless trading device (e.g., the wireless trading device 502) assigned to access the next update (e.g., the third update) of the common market data in the update cycle remains present in the distribution network 400 (block 718). If the device identification module 602 identifies that the next wireless trading device remains in the distribution network 400, the handoff relay module 608 relays the handoff indicator to the wireless trading device assigned to access the next update (block 720).

If the device identification module 602 determines that the next wireless device (e.g., the wireless trading device 502) in the update cycle is disconnected from the distribution network 400, the device identification module 602 determines whether other wireless trading devices (e.g., at least two of the wireless trading devices 402, 404, 504, 506) remain in the distribution network 400 (block 902). If the device identification module 602 determines that no other and/or only one other wireless trading device remains in the distribution network 400, the method 900 ends and/or returns to the start.

Otherwise, if the device identification module 602 determines that other wireless trading devices are present in the distribution network 400, the update cycle scheduler 604 assigns one of the remaining wireless trading devices to replace the disconnected wireless trading device within the update cycle (block 904). For example, if the update cycle scheduler 604 assigns the wireless trading device 506 to replace and/or or fill in for the wireless trading device 502, the wireless trading device 506 thereafter accesses the third and eighth updates that were previously assigned to the wireless trading device 502. In some examples in which a lead device (e.g., the wireless trading device 402) is selected within the distribution network 400, the lead device is designated as a default replacement wireless trading device.

After the replacement wireless trading device is assigned by the update cycle scheduler 604, the handoff relay module 608 relays the handoff indicator to the newly assigned wireless trading device (block 720). As illustrated in FIG. 7, blocks 714, 716, 718, 902, 904, 720 repeat until two or less wireless trading devices remain in the distribution network 400.

For example, three traders (e.g., Adam, Brian, and Carol) may go out to lunch together and each brings a wireless device that runs an electronic trading platform. For examples, Adam brings a smart phone that runs the electronic trading platform, Brian brings a tablet that runs the electronic trading platform, and Carol brings a netbook that runs the electronic trading platform. Because Adam, Brian, and Carol are in close proximity to each other, the corresponding smart phone, tablet, and netbook are in communication with each other via an ad hoc network (e.g., a network utilizing Bluetooth® protocol).

Each of the three traders may request market data related to a particular tradeable object such as the 10-year U.S. Treasury Notes futures contract that is of interest to one or more of the other three traders. For example, at least some of the market data requested by the smart phone of Adam is also requested by the tablet of Brian and the netbook of Carol. If the devices of Adam, Brian and Carol were each to access the commonly requested market data, an exchange and/or a gateway would provide the same market three times to the three devices that are in communication with each other via the ad hoc network. As a result, the smart phone of Adam, the tablet of Brian, and the netbook of Carol would each consume a portion of data allotted to the respective device.

To prevent the three devices each from accessing data that consumes a portion of its designated data allotment, each of the three devices are assigned to access an update of the mutually requested market data and subsequently distribute the accessed market data via the ad hoc network. For example, the smart phone of Adam accesses a first update of the common market data from the exchange and/or the gateway and distributes the accessed data to the tablet of Brian and the netbook of Carol. The tablet of Brian subsequently accesses a second update from the exchange and/or the gateway and distributes the accessed data to the smart phone of Adam and the netbook of Carol. Afterwards, the netbook of Carol accesses a third update from the exchange and/or the gateway and distributes the accessed data to the smart phone of Adam and the tablet of Brian. As a result, the amount of data consumed by each of the three devices is reduced to a third of what would have otherwise been consumed.

In some examples, one of the devices may no longer be in communication with the other devices via the ad hoc network. For example, the tablet of Brian may run out of battery power. In some such examples, the smart phone of Adam and the netbook of Carol continue to distribute updates of the common market data via the ad hoc network. Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
assigning a first wireless device of a plurality of wireless devices to access a first update of common market data from an exchange and a second wireless device of the plurality of wireless devices to access a second update of the common market data from the exchange upon receiving a handoff indicator;
accessing the first update via a first network between the exchange and the first wireless device; and
relaying the handoff indicator to the second wireless device after the first update is accessed, wherein the second wireless device is to access the second update from the exchange via a second network after the handoff indicator is received from the first wireless device.

2. The method of claim 1, further comprising distributing the first update to the second wireless device and the second update to the first wireless device via a shared communication network.

3. The method of claim 1, further comprising:
assigning a third wireless device of the plurality of wireless devices to access a third update of the common market data from the exchange via a third network; and
relaying the handoff indicator to the third wireless device after the second update is accessed, wherein the third wireless device is to access the third update after the handoff indicator is received from the second wireless device.

4. The method of claim 1, wherein accessing the first update of the common market data comprises:
requesting the first update via the first network;
identifying whether the common market data has changed;
if the common market data remains unchanged for a period of time, sending a standby indicator to the plurality of wireless devices that the first wireless device is waiting for the first update of the common market data; and
once the common market data has changed, receiving the first update from the exchange via the first network.

5. The method claim 1, further comprising scheduling an iterative cycle to access updates of the common market data, wherein the iterative cycle includes assigning the first wireless device to access a third update of the common market data and assigning the second wireless device to access a fourth update of the common market data.

6. The method claim 5, further comprising, if the second wireless device disconnects prior to relaying the handoff indicator after one of the updates assigned to the second wireless device, assigning the first wireless device to replace the second wireless device in the iterative cycle or rescheduling the iterative cycle without the second wireless device.

7. A tangible computer readable storage medium comprising instructions which, when executed, cause a machine to at least:
assign a first wireless device of a plurality of wireless devices to access a first update of common market data from an exchange and a second wireless device of the plurality of wireless devices to access a second update of the common market data from the exchange upon receiving a handoff indicator;
access the first update via a first network between the exchange and the first wireless device; and
relay the handoff indicator to the second wireless device after the first update is accessed, wherein the second wireless device is to access the second update from the exchange via a second network after the handoff indicator is received from the first wireless device.

8. The tangible computer readable storage medium of claim 7, wherein the machine is the first wireless device, the second wireless device, or a gateway.

9. The tangible computer readable storage medium of claim 7, wherein, before the instructions cause the machine to access the first update, the instructions further cause the machine to distribute the first update to the second wireless device and the second update to the first wireless device via a shared communication network.

10. The tangible computer readable storage medium of claim 7, wherein the instructions further cause the machine to:
assign a third wireless device of the plurality of wireless devices to access a third update of the common market data from the exchange via a third network; and
relay the handoff indicator to the third wireless device after the second update is accessed, wherein the third wireless device is to access the third update after the handoff indicator is received from the second wireless device.

11. The tangible computer readable storage medium of claim 7 wherein, to access the first update of the common market data, the instructions further cause the machine to:
request the first update via the first network;
identify whether the common market data has changed;
if the common market data remains unchanged for a period of time, send a standby indicator to the plurality of wireless devices that the first wireless device is waiting for the first update of the common market data; and
once the common market data has changed, receive the first update from the exchange via the first network.

12. The tangible computer readable storage medium of claim 7, wherein the instructions further cause the machine to schedule an iterative cycle to access updates of the common market data, the iterative cycle assigns the first wireless device to access a third update of the common market data and assigns the second wireless device to access a fourth update of the common market data.

13. The tangible computer readable storage medium of claim 12, wherein, if the second wireless device disconnects prior to relaying the handoff indicator after one of the updates assigned to the second wireless device, the instructions further cause the machine to assign the first wireless device to replace the second wireless device in the iterative cycle or to reschedule the iterative cycle without the second wireless device.

14. A system comprising a computing device configured to:
assign a first wireless device of a plurality of wireless devices to access a first update of common market data from an exchange and a second wireless device of the plurality of wireless devices to access a second update of the common market data from the exchange upon receiving a handoff indicator;
access the first update via a first network between the exchange and the first wireless device; and
relay the handoff indicator to the second wireless device after the first update is accessed, wherein the second wireless device is to access the second update from the exchange via a second network after the handoff indicator is received from the first wireless device.

15. The system of claim 14, wherein the computing device is the first wireless device, the second wireless device, or a gateway.

16. The system of claim 14, wherein, before the computing device is configured to access the first update, the computing device is further configured to distribute the first update to the second wireless device and the second update to the first wireless device via a share communication network.

17. The system of claim 14, wherein the computing device is further configured to:
assign a third wireless device of the plurality of wireless devices to access a third update of the common market data from the exchange via a third network; and
relay the handoff indicator to the third wireless device after the second update is accessed, wherein the third wireless device is to access the third update after the handoff indicator is received from the second wireless device.

18. The system of claim 14, wherein, to access the first update of the common market data, the computing device is further configured to:
request the first update via the first network;
identify whether the common market data has changed;
if the common market data remains unchanged for a period of time, send a standby indicator to the plurality of wireless devices that the first wireless device is waiting for the first update of the common market data; and
once the common market data has changed, receive the first update from the exchange via the first network.

19. The system of claim 14, wherein the computing device is further configured to schedule an iterative cycle to access updates of the common market data, the iterative cycle assigns the first wireless device to access a third update of the common market data and assigns the second wireless device to access a fourth update of the common market data.

20. The system of claim 19, wherein, if the second wireless device disconnects prior to relaying the handoff indicator after one of the updates assigned to the second wireless device, the computing device is further configured to assign the first wireless device to replace the second wireless device within the iterative cycle or to reschedule the iterative cycle without the second wireless device.
